(19) United States
(12) Patent Application Publication
(10) Pub. No.: US 2004/0131263 A1
(43) Pub. Date: Jul. 8, 2004

(54) Image processing apparatus

(76) Inventors: Hiroyuki Kawamoto, Kanagawa (JP); Isao Miyamoto, Kanagawa (JP); Tomoyuki Yoshida, Tokyo (JP); Satoshi Ohkawa, Tokyo (JP); Atsushi Togami, Kanagawa (JP); Taira Nishita, Kanagawa (JP); Yasunobu Shirata, Tokyo (JP); Maki Ohyama, Tokyo (JP)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 10/687,625

(22) Filed: Oct. 20, 2003

(30) Foreign Application Priority Data
Oct. 18, 2002 (JP) 2002-304623

(51) Int. Cl. G06K 9/36; G06K 9/00

(52) U.S. Cl. 382/232; 382/166

(57) ABSTRACT

A hard disk drive (HDD) stores a plurality of image data in a first format in a compressed form. An image format converter converts the format of the image data to a second format. The second format is a general format, as such as JPEG or TIFF. When transmitting the image data to an external PC, the image data in both the first format and the second format is transmitted.

### BACKGROUND OF THE INVENTION

1) Field of the Invention

The present invention relates to an image processing apparatus that converts format of data when sending the data to an external device for backup.

2) Description of the Related Art

Digital copying machines include a larger capacity hard disk drive (HDD) for storing data. Data is temporarily stored in such the HDD during copying operation using an electronic sort function. However, the HDD of recently provided digital copying machines has a larger storage capacity such that data input through printing is continuously stored, and the stored data is re-used. Thus, the storage function of data becomes increasingly important. The electronic sort function is a function of electronically controlling output of data by controlling access to a memory or a storage unit that stores data for a page document.

However, the HDD is quite fragile to mechanical shock to be sometimes damaged, and important data stored therein may be lost. Therefore, the data stored in the HDD is required to be backed up in a computer connected to a network.

A technology disclosed Japanese Patent Application Laid Open (JP-A) No. 2000-32241 is a conventional example of a system intended to back up data having been printed out by a copying machine.

The technology disclosed in JP-A No. 2000-32241 is a system of providing a server on an intranet connected with a copying machine and backing up copied data in a mass-storage device of the server. In this invention, a part of text data (e.g., thumbnail images on a header page) stored in the mass-storage device and additional data (operating mode, document and paper conditions, number of sheets to be copied, or image processing conditions for copying) are read out and displayed according to a request from a user. The data to be reused is selected from the displayed text data, and the selected data is transferred to the copying machine.

However, when the data having been used for printing out by the copying machine is to be compressed and stored in the mass-storage device such as HDD, the data is generally formatted specifically to the printing process of the copying machine so as to allow increase in processing efficiency. Therefore, even if the image stored in the specific format in the HDD of the copying machine is read out by an external device that backs up the image, the contents of the image is impossible to be viewed unless a unit for decoding the specific format is provided. In particular, when different types of image data are input using the multifunction and the input image data is stored in the HDD of the copying machine like a multifunction type color copying machine, pieces of data to be stored have been processed in various types of formats, which makes it further difficult to solve the problem.

It is noted that JP-A No. 2000-32241 does not describe the technology of a format of the data stored in the mass-storage device that backs up data having been used for copying. However, in this example, when the stored backup data is to be fetched, the user can select and specify the stored data, and therefore, it is disclosed that a part of the stored text data is displayed. Consequently, it is required to prepare a format suitable for the format of the stored data. Particularly, the multifunction type color copying machine requires provision of a format converter suitable for each of image types, and therefore, it is needed to provide a dedicated server, which results in the lack of general versatility of the system.

In order to solve the problems occurring in the method of storing data backed-up in the specific format, a method as follows has been studied ((hereinafter, “preceding example”), that is, the method of converting the specific format in the copying machine into JPEG (Joint Photographic Experts Group) as a general compression format and storing this compression format in the external device as backup data.

According to the preceding example, a general format converter can be used. Therefore, data contents can be identified by external devices each provided with the format converter, which makes it easy to execute backing up. However, in the process of converting the specific format in the copying machine to JPEG, the image may be degraded, and the degraded image is not suitable as data used for backing up.

### SUMMARY OF THE INVENTION

It is an object of the present invention to solve at least the problems in the conventional technology.

An image processing apparatus includes an image storage unit that stores a plurality types of image data in a first data format and that is compressed; a data format converter that converts the first data format of the image data to a second data format being a general data format; and a communicator that includes a communication interface that transmits the image data of the first data format and the image data of the second data format as reference image data for the image data of the first data format.

These and other objects, features and advantages of the present invention are specifically set forth in or will become apparent from the following detailed descriptions of the invention when read in conjunction with the accompanying drawings.

### BRIEF DESCRIPTION OF THE DRAWINGS

FIG. 1 is a block diagram schematically illustrating a system configuration of a digital color copying machine according to first to third embodiments of the present invention;

FIG. 2 illustrates an internal configuration of a scanning correction section of FIG. 1;

FIG. 3 illustrates an internal configuration of a printing correction section of FIG. 1;

FIG. 4 illustrates an internal configuration of an image format converter of FIG. 1 according to the first embodiment of the present invention;

FIG. 5 illustrates one example of a smoothing filter used for multinary processing in the image format converter;

FIG. 6 is a diagram of resolution conversion processing in the image format converter;

FIG. 7 illustrates one example of a color space converter from CMYK to RGB used in the image format converter;

FIG. 8 illustrates an internal configuration of the image format converter of FIG. 1 according to the second embodiment of the present invention; and

FIG. 9 illustrates an internal configuration of the image format converter of FIG. 1 according to the third embodiment of the present invention.

### DETAILED DESCRIPTION

Exemplary embodiments of the image processing apparatus according to the present invention are explained in detail below with reference to the accompanying drawings. In the embodiments of this specification, the image processing apparatus of the present invention is applied to a digital color copying machine that combines a copying function, a facsimile (FAX) function, a printing function, and a function of transmitting an input image (a read document image, and an image input by the printing function or the FAX function) that has been stored in the copying machine.

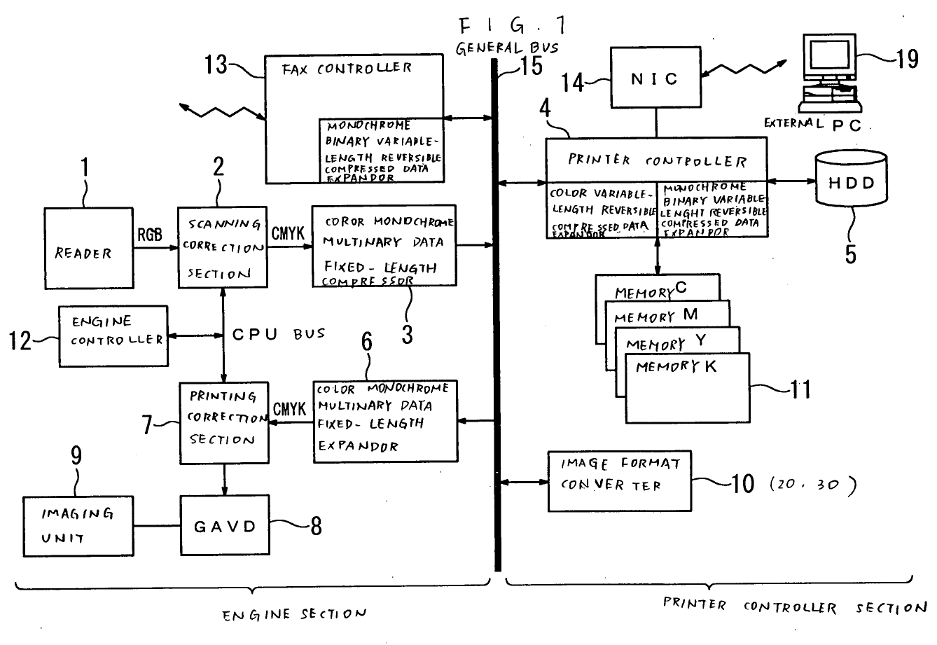

FIG. 1 is a block diagram schematically illustrating a system configuration of a digital color copying machine according to first to third embodiments of the present invention. The system of the digital color copying machine includes a multifunction such as functions of a copying machine, a FAX, and a printer, and also includes a function of transmitting input image data that has been stored.

As components used for the copying function, the digital color copying machine includes a reader 1, a scanning correction section 2, a color monochrome multinary data fixed-length compressor 3, and a hard disk drive (HDD) 5. The reader 1 reads a document as color image data, and the scanning correction section 2 subjects the read image data to image processing. The color monochrome multinary data fixed-length compressor 3 compresses color monochrome multinary data output from the scanning correction section 2, and the HDD 5 stores compressed data.

As a component used for the FAX function, the digital color copying machine includes a FAX controller 13 like in existing multifunction machines. The FAX controller 13 includes a monochrome binary variable-length reversible compressed data expandor that connects to a public switched telephone network (PSTN) to receive and transmit FAX signals, and decompresses the received compressed FAX data to the original data.

As components used for the printing function, the digital color copying machine includes a network interface controller (NIC) 14 for performing communications with an external PC 19 connected to a network in this embodiment, and a printer controller 4 that performs raster image processing (RIP) according to a printing command from the external PC 19 through the NIC 14 and performs specific compression on data after the RIP.

As a component used for the function of transmitting input image data that has been stored, the digital color copying machine also includes an image (data) format converter 10 (explained in detail in the latter part). The image format converter 10 converts the format of the data that is generated when the copying, FAX, and printing functions are used and is stored in the HDD 5, into a general data format so that a target external device (external PC 19 in the embodiment) can easily perform processing.

In a case of printing out an image (image formation process) based on image data that is generated by using these functions, the data stored in the HDD 5 is used in this embodiment. Therefore, for the copying function, the digital color copying machine has a color monochrome multinary data fixed-length expandor 6 that can expands the stored compressed data to its original data form. On the other hand, for the FAX and printing functions, the digital color copying machine has a monochrome binary variable-length reversible compressed data expandor and color variable-length reversible compressed data expandor provided in the printer controller 4. The digital color copying machine also includes an engine section as means for performing image forming processing. The engine section includes a printing correction section 7 that corrects the expanded data, GAVD 8, and an imaging unit 9. It is noted that an engine section for the scanning correction section 2 and the printing correction section 7 is controlled by an engine controller 12.

The functions and operations of the digital color copying machine are explained in more detail below.

The process required for using the copying function is explained first.

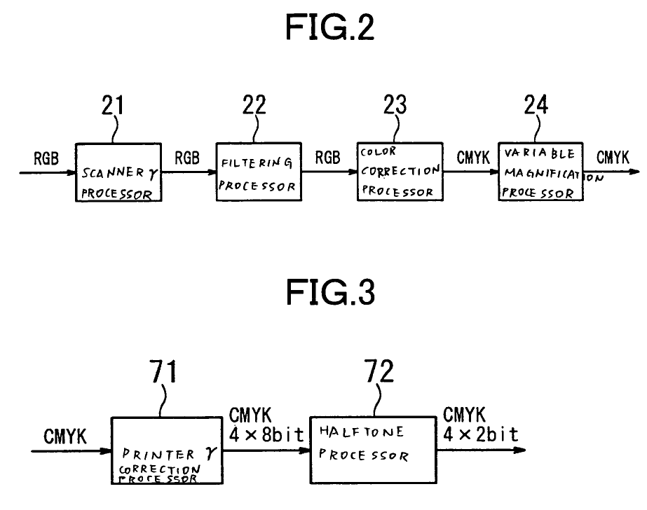

The reader 1 reads a document placed on a document table and separates color data of the document into R, G, and B (R: red, G: green, and B: blue), and the data is transmitted to the scanning correction section 2. FIG. 2 illustrates an internal configuration of the scanning correction section 2. The scanning correction section 2 includes a scanner y processor 21 that performs scanner y processing, a filtering processor 22 that performs filtering, a color correction (conversion) processor 23 that performs color correction, and a variable magnification processor 24 that performs variable magnification. The color correction processor 23 converts color signals of a scanned RGB image into image data for four-color components of C, M, Y, and K (C: cyan, M: Magenta, Y: yellow, and K: black).

Color data of eight bits for each color of C, M, Y, and K after variable magnification is compressed by the color monochrome multinary data fixed-length compressor 3 and then converted into color data of two bits for each color.

The CMYK image data compressed by the color monochrome multinary data fixed-length compressor 3 is transmitted to the printer controller 4 through a general bus I/F 15. The printer controller 4 has separate semiconductor memories 11 for each color of C, M, Y, and K colors, respectively, and stores the same data as transmitted data in these memories. Since the resolution of the scanned image in the present embodiment is 600 dpi, the storage resolution for copying is 600 dpi.

The stored data is written in the HDD 5 whenever necessary. The reason for storing the data in the HDD 5 is to avoid re-reading of a document when a paper is jammed during printing and the printing is not successfully completed. Another reason for storing the data in the HDD 5 is to perform the electronic sorting. In recent years, another function of storing the read document in the HDD 5 and outputting again the document as necessary is added to the functions. The present embodiment allows the digital color copying machine to be used for such a copy server function.

In any of the cases, an image is formed by using the data stored in the HDD 5 for printing. Therefore, when the print is to be output, the compressed data of CMYK in the HDD 5 is developed once over the semiconductor memories 11. Then, the data is transmitted to the engine section through the general bus 15. The data is expanded once again to image data of eight bits of CMYK by the color monochrome multinary data fixed-length expandor 6 in the engine section. The expanded data is transmitted to the printing correction section 7.

FIG. 3 illustrates the internal configuration of the printing correction section 7. The printing correction section 7 includes a printer y correction processor 71 that performs printer y correction on each color of CMYK. The printing correction section 7 further includes a halftone processor 72 that performs halftone processing, adapting to the GAVD 8 and the imaging unit 9, on each of the colors, and transmits the processed color data for imaging to the next stage, where the image is formed on a transfer paper to be output.

The copying operation for a color copy is explained above. A copying operation for a monochrome copy can also be performed in the digital color copying machine. In the case of the copying operation for the monochrome copy, the color correction processor 23 (FIG. 2) in the scanning correction section 2 converts a scanned RGB image to a grey scale image of eight bits. This converted image data is compressed in the color monochrome multinary data fixed-length compressor 3. The compressed image data is transmitted to the printer controller 4 through the general bus 15 and stored in a K plane of the memories 11. A compressed grey scale image in the K plane is stored in the HDD 5.

The printing function operates when a print request is issued from the external PC 19 that is connected thereto through the NIC 14. Since any existing unit can be applied to the printer controller 4, the operation of the printer controller 4 is not explained in detail. However, an image subjected to raster image processing (hereinafter, “RIP image”) that is used as drawing data in the engine section is generated according to the print request received from the external PC 19. When the color printing operation is performed, the RIP image data is generated as data of low bits of about one to four bits for each of CMYK colors. When the monochrome printing operation is performed, the RIP image data is generated as data of one bit in only the K plate.

Here, the CMYK or K image that is subjected to RIP is stored in the HDD 5. However, since the size of the data subjected to the RIP is large, the data consumes very large memory when stored in the memory without compressing it. Therefore, in the same manner as the case of using the copying function, the data is compressed and then stored in the HDD 5. The special variable-length reversible compressors in the printer controller 4 for color and monochrome compress the data. Resolution of an input image for printing may be 300 dpi, 600 dpi, 1200 dpi, or the like, and the data having any of the resolutions is stored in the HDD 5.

Further, the FAX function starts its operation upon FAX reception in the FAX controller 13. As the FAX controller 13 can be provided with any existing ordinary means, the operation thereof is not explained in detail. Herein, explanation is given to the operation in which the monochrome binary variable-length reversible compressed data expandor expands the received compressed FAX signal to the original data, and the engine section generates an RIP image to be used as drawing data.

The generated RIP image is stored in the HDD 5. However, as the size of the data after RIP is large, the extremely large capacity of memory is consumed if the data is stored on the memory without compression. Therefore, the data is compressed and the compressed data is stored in the HDD 5. The compression processing is performed by a special variable-length reversible compressor provided in the printer controller 4 in the same manner as that of the printing function. The resolution of an input image upon FAX reception may be 200 dpi, 300 dpi, and 400 dpi, and the data having any of the resolutions is stored also in the HDD 5.

As explained above, pieces of data having been compressed in various formats and having different resolutions exist on the HDD 5 of the digital multifunction machine according to the embodiment.

The summary of the compression formats and the resolutions of the image data in the HDD is as shown in table 1.

TABLE 1

| Data format | Compression format | Resolution |
|---|---|---|
| copy (color) | multinary irreversible fixed-length | 600 dpi |
| | compression (CMYK) | |
| copy | multinary irreversible fixed-length | 600 dpi |
| (monochrome) | compression (K) | |
| printer (color) | reversible variable-length | 300, 600 dpi |
| | compression | |
| printer | binary reversible variable-length | 300, 600, |
| (monochrome) | compression | 1200 dpi |
| FAX | binary reversible variable-length | 200, 300, |
| | compression | 400 dpi |

Therefore, when a print is to be output using the data generated by the functions of the copying machine, printer, and FAX and stored in the HDD 5, the data compressed for storage has to be expanded and changed to printing data in the engine section. In other words, the image obtained through the copying function is expanded by the color monochrome multinary data fixed-length expandor 6, while the image obtained through the FAX and printing functions is expanded by the monochrome binary variable-length reversible compressed data expandor and the color variable-length reversible compressed data expandor in the printer controller 4. The expanded data is transmitted to the engine section as data for image formation.

As explained above, the system employs the method of temporarily storing the input image in the HDD 5 as compressed data and fetching the stored data from the HDD 5 to use it. In this system, the data stored in the HDD 5 is transmitted also in the case of using the function of transmitting input image data that has been stored.

However, there are various types of the image data stored in the HDD 5, and any of the data is processed in a specific format. Therefore, even if the image data is transferred to an external device (PC 19 in FIG. 1) as it is, the external device may not, in many cases, handle the format of the image data, and therefore, the image data cannot easily be found out what type of data it is. Further, even if the format of the image data is converted to a general image format, the multinary data fixed-length compression format for copying in particular is irreversible, and therefore, the image quality is degraded. Consequently, the image of which format has been converted is also impossible to be used again as a backup of the data for storage.

In the present invention, if an external device (PC 19) receiving the stored data has a general process function, it is possible to identify the contents of the received stored data, and it is also possible to obtain the data, having been processed in various types of compression formats, stored in the HDD 5 without degradation of the data.

In order to obtain such data, in the embodiments, the image format converter 10 is provided in the controller section to create a reference image of the general format in real time, and the reference image is transmitted to the external device (PC 19) together with its original image stored in the HDD 5.

In the following embodiments, the conversion process of data format is exemplified and explained. More specifically, the data format is used to transmit the data stored when a color or monochrome image has been printed out using any of the functions of the copying machine, printer, and FAX, to the external device (PC 19).

In the following embodiments, data for various types of images stored in data forms (data format, compression format, resolution) as shown in the table 1 is targeted and cases as follows are explained. A compressor to be provided in a final stage, for converting the format of the data to the general format of a reference image to be transmitted, depends on the cases. In some of the cases, a single multinary compressor is used (first embodiment), and two compressors are used as a multinary compressor for color data and as a binary compressor for monochrome data (second embodiment). In another case, three compressors in total are used, that is, two types of multinary compressors are used for each color data of a copying machine and a printer that has been subjected to different color conversion, and one binary compressor is used for monochrome data (third embodiment). In another case, the identification of an image is provided by controlling a conversion rate of resolution (fourth embodiment).

The first embodiment of the present invention is explained below. When image data of various formats stored in the HDD 5 is to be transmitted to the external PC 19 in order to use it as a backup or the like, an image processing apparatus of the first embodiment converts the format of stored data into a single general image format to create an image for reference. The image processing apparatus then transmits the reference image as backup data together with its original image data. Accordingly, even if the stored data is specifically formatted, it is possible to easily identify the contents of the data by the reference image when used in the external PC 19, and further, to prevent degradation in image quality by using the original image data.

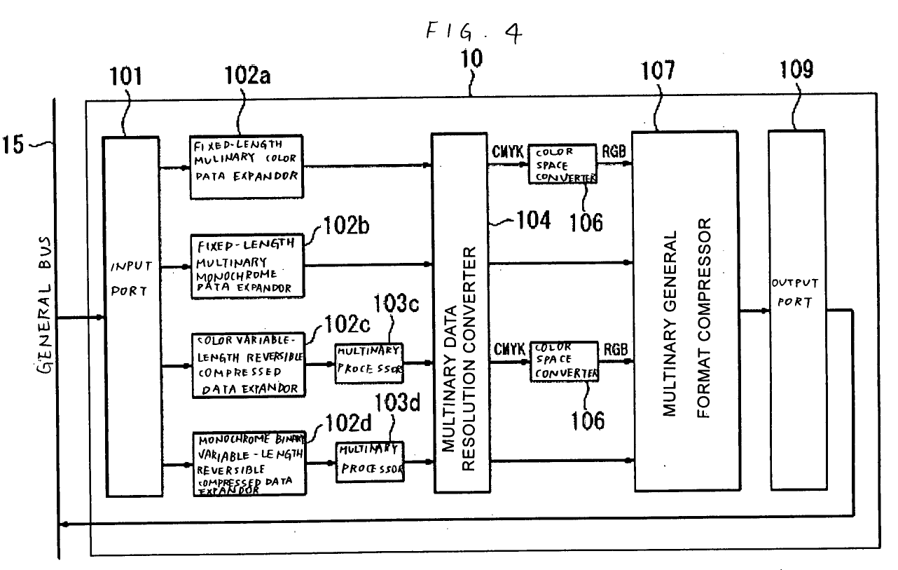

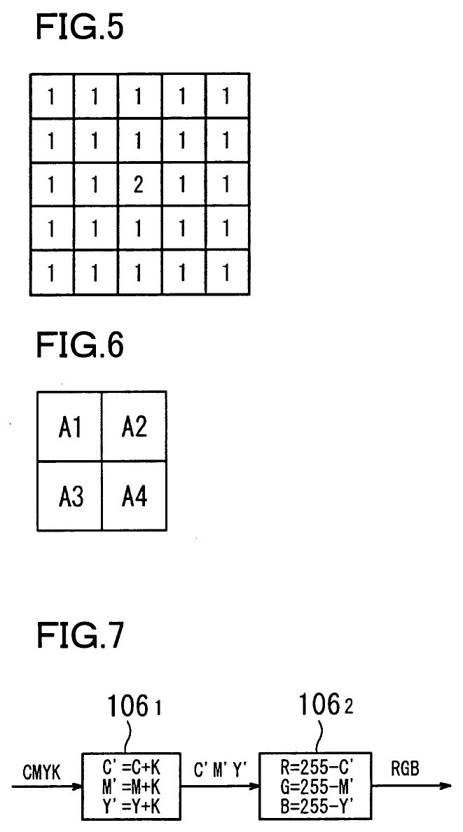

FIG. 4 illustrates one example of the image format converter 10 that converts stored data to a reference image and performs processing thereon according to the first embodiment.

The configuration and operation of the image format converter 10 are explained below with reference to FIG. 4. Image data compressed in various formats developed over the semiconductor memories 11, where CMYK data are stored, connected to the printer controller 4 is transmitted to the image format converter 10 through the general bus 15. In the image format converter 10, the data passing through an input port 101 is led to a different expandor depending on the format of the data, and expanded therein. In this embodiment, the image format converter 10 includes a fixed-length multinary color data expandor 102a, a fixed-length multinary monochrome data expandor 102b, a color variable-length reversible compressed data expandor 102c, and a monochrome binary variable-length reversible compressed data expandor 102d, which correspond to the respective compression formats in the table 1.

The resolution of the image converted to multinary data is reduced to a desired resolution by a multinary data resolution converter 104. In the resolution conversion performed herein, an arbitrary conversion rate is basically set, but the case of reducing the resolution is explained herein because the purpose here is to create a reference image. For example, if the resolution is reduced to one-half such as from 600 dpi to 300 dpi, a method of performing resolution conversion by obtaining a pixel average of adjacent pixels A1 to A4 as illustrated in FIG. 6 and thinning the pixels, can be employed. By creating the reference image, the resolution of a final image is made constant irrespective of the resolution of its original data. Therefore, the format of the data can be converted to an appropriate form in which the data is displayed on the screen of the external PC 19 to be easily viewed.

Thereafter, the stored color data for CMYK is converted to data for an RGB system. Because the CMYK data is device (printer)-dependent and low in versatility, the CMYK data has to be converted to data for the RGB system that has high versatility in order to use the data on PC. FIG. 7 illustrates one example of a color space converter 106 that converts CMYK to RGB. The conversion method used here is executed in such a manner as follows. In a first-stage color converter 106₁, CMYK is converted to C′M′Y′ (C′=C+K, M′=M+K, Y′=Y+K), and in a second-stage color converter 106₂, C′M′Y′ is converted to RGB (R=255-C′, G=255-M′, B=255-Y′). When color data is converted to the RGB system, a method with higher accuracy has to be used for accurate conversion of the data to a particular color space such as sRGB. However, the reference image as a target of the first embodiment requires only the overview of colors. Therefore, a converter that simply calculates complementary colors as illustrated in FIG. 7 may be used.

Image data is subjected to color conversion and resolution thereof is reduced. This image data is then processed by a multinary general format compressor 107 to obtain a target compressed image for reference. In this embodiment, based on the configuration as illustrated in FIG. 4, the data of various formats stored in the semiconductor memories 11 and the HDD 5 of the printer controller 4 is converted to data compressed in one type of format having the same resolution obtained by reducing respective resolutions. The converted data is transmitted to the external PC 19 as the reference image. The resolution of thumbnail images for reference is generally reduced to 100 dpi, and therefore, these images may be created with about this value. The reference image created in the image format converter 10 in the above manner is transmitted again to the printer controller 4 from an output port 109 through the general bus 15.

The printer controller 4 transmits the image compressed and stored in the HDD 5 through the semiconductor memories 11 when the image is input and the compressed image for reference created in the image format converter 10, to the external PC 19 through the NIC 14. The external PC 19 integrally manages the compressed images to allow the contents of the compressed data to be easily identified and the stored image with high image quality to be ensured. Therefore, it is possible to manage these compressed data in the external PC 19 as backup data for the compressed data stored in the copying machine. When the backup data is to be used again, the compressed data for reference is abandoned on the external PC 19, but only the data of an internal compression format is returned to the printer controller 4 through the NIC 14, and is stored in the HDD 5.

The second embodiment of the present invention is explained below. The image data of various formats stored in the HDD 5 includes data for color images, monochrome images, and multinary and binary data. When a reference image is to be created, an image processing apparatus of the second embodiment converts the format of a color image into a multinary general format, and converts the format of a monochrome image into a binary general format irrespective of multinary data or binary data. By doing so, it is possible to reduce data amount of a reference image to be created as compared with the first embodiment in which all the image data is converted to multinary data and process is performed thereon.

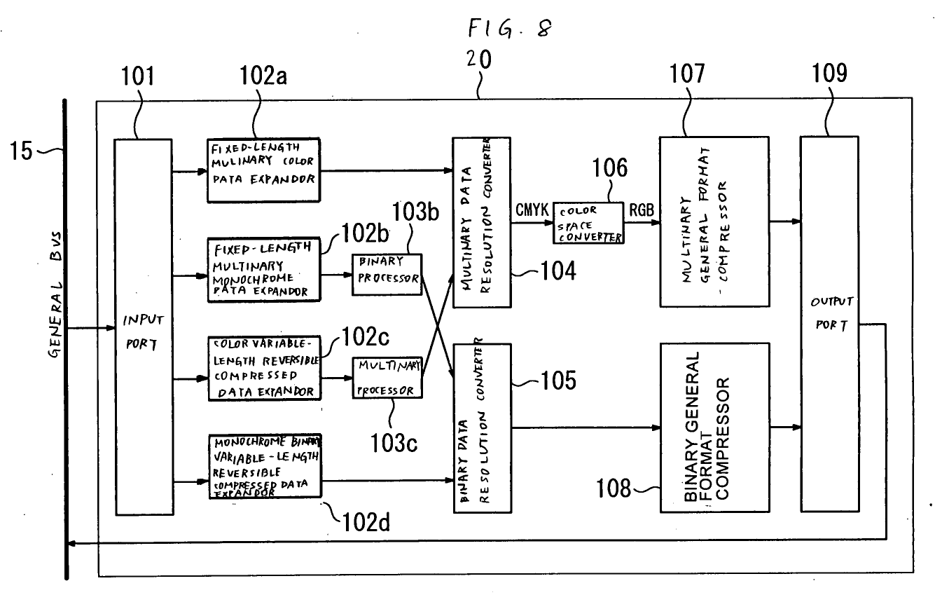

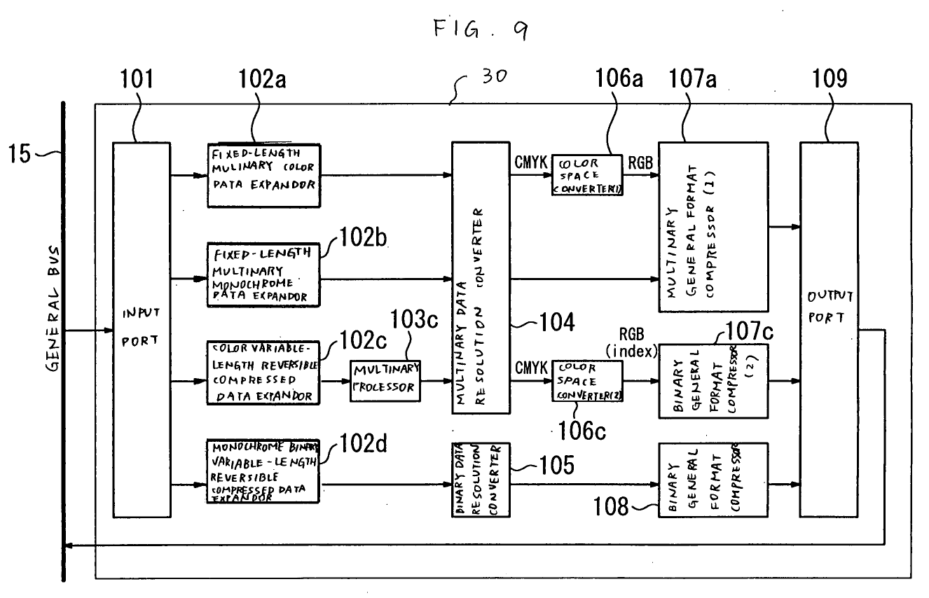

FIG. 8 illustrates one example of an image format converter 20 that converts image data to a reference image and performs processing thereon according to the second embodiment.

The configuration and operation of the image format converter 20 is explained with reference to FIG. 8. The fact that the various types of data are stored in the HDD 5 of the printer controller 4 is the same as that of the first embodiment. In this embodiment, the image format converter 20 in the printer controller creates an image for reference of a different general format in real time according to whether its original image stored in the HDD 5 is monochrome or color. The image data of various formats on the CMYK semiconductor memories 11 connected to the printer controller 4 is transmitted to the image format converter 20 through the general bus 15.

The image format converter 20 includes the fixed-length multinary color data expandor 102a, the fixed-length multinary monochrome data expandor 102b, the color variable-length reversible compressed data expandor 102c, and the monochrome binary variable-length reversible compressed data expandor 102d, which correspond to the respective compression formats in the table 1. The data is led to any of the expanders depending on its data format, and is expanded therein.

Since a color image is converted to multinary data and a monochrome image is converted to binary data, multinary color data is directly transmitted to the multinary data resolution converter 104. However, multinary monochrome data is converted to binary data in a binary processor 103b, and the converted data is transmitted to the binary data resolution converter 105. The color data that has been subjected to variable-length reversible compression and RIP in the printer controller 4 is converted to multinary data in a multinary processor 103c, and the converted data is transmitted to the multinary data resolution converter 104. The binary monochrome data that has been subjected to variable-length reversible compression and RIP in the printer controller 4 is directly transmitted to the binary data resolution converter 105.

In the above manner, the color data is integrated into multinary data and the monochrome data is integrated to binary data. Thereafter, multinary data of CMYK is converted to the RGB system by a color space converter 106 in the same manner as that of the first embodiment. The RGB data after color conversion is transmitted to the multinary general format compressor 107. On the other hand, the binary data is transmitted to a binary general format compressor 108. The images having been compressed in the format compressors are transmitted again to the semiconductor memories 11 on the printer controller 4 from the output port 109 through the general bus 15, and are handled as reference images.

The printer controller 4 transmits the image compressed and stored in the HDD 5 through the semiconductor memories 11 when the image is input and the compressed image for reference created in the image format converter 20, to the external PC 19 through the NIC 14. The external PC 19 integrally manages the compressed images to allow the contents of the compressed data to be easily identified and the stored image with high image quality to be ensured. Therefore, it is possible to manage these compressed data in the external PC 19 as backup data for the compressed data stored in the copying machine. When the backup data is to be used again, the compressed data for reference is abandoned on the external PC 19, but only the data in an internal compression format is returned to the printer controller 4 through the NIC 14, and is stored in the HDD 5.

As explained above, in the second embodiment, if the original data stored in the HDD 5 is a monochrome image, a monochrome binary image is created as reference data. Therefore, it is possible to economize on the size of a file for reference for monochrome as compared with the first embodiment. Further, as the monochrome image is most frequently used even in a color multifunction machine, the effective method can be provided.

The third embodiment of the present invention is explained below. An image processing apparatus of the third embodiment transmits an image for reference created from the stored data together with its stored original data to the external PC 19, in order to use the data for images such as a color image, a monochrome image, and multinary and binary images stored in the HDD 5 in specific formats, as backup or the like. In this embodiment, the reference image is obtained by converting the format of a multinary color image into a multinary general format for color, and converting the format of a multinary monochrome image into a multinary general format. The reference image is also obtained by converting the format of a low-bit color image like a color printer image into a general format of an index color format, and converting the format of a binary image like a monochrome printer image into a binary monochrome general format. By using such a format of the reference image, it is possible to identify how the original image has been obtained.

Table 2 as illustrated below summarizes the reference images of this embodiment created in real time in an image format converter 30 of the printer controller, according to a type of image. In this table, data formats and compression formats are given as types of original images stored in the HDD 5, and reference image formats are given in a one-to-one correspondence with the above-mentioned formats.

TABLE 2

| | | Reference image |
|---|---|---|
| Data format | Compression format | format |
| copy (color) | multinary irreversible | multinary general |
| | fixed-length compression | format (color) |
| | (CMYK) | |
| copy | multinary irreversible | multinary general |
| (monochrome) | fixed-length compression | format (monochrome) |
| | (K) | |
| printer (color) | reversible variable-length | multinary general |
| | compression | format (color) |
| printer | binary reversible | binary general format |
| (monochrome) | variable-length compression | (monochrome) |
| FAX | binary reversible | binary general format |
| | variable-length compression | (monochrome) |

As given in table 2, when an image is a color copy image, its reference image is output using the multinary general format for color. When an image is a monochrome copy image, its reference image is output using the multinary general format for monochrome. Further, when an image is a color printer image, its reference image is output using the multinary general format for color. However, the number of colors is not required as many as the case of the copy one, and therefore, a general format, like TIFF (Tagged Image File Format), that supports index colors is suitable from the view of data size. When an image is a monochrome printer image, its reference image is output using the binary general format. In this case, the general format that supports binary data like the TIFF is suitable.

FIG. 9 illustrates one example of the image format converter 30 that converts image data to a reference image and performs processing thereon according to the third embodiment.

The configuration and operation of the image format converter 30 are explained below with reference to FIG. 9. Image data of various formats on the semiconductor memories 11 for CMYK connected to the printer controller 4 is transmitted to the image format converter 30 through the general bus 15.

The image format converter 30 includes the fixed-length multinary color data expandor 102a, the fixed-length multinary monochrome data expandor 102b, the color variable-length reversible compressed data expandor 102c, and the monochrome binary variable-length reversible compressed data expandor 102d, which correspond to the respective compression formats in the table 1. The data is led to any of the expandors depending on its data format, and is expanded therein.

Thereafter, the multinary color data and monochrome data are directly transmitted to the multinary data resolution converter 104. The color data that has been subjected variable-length reversible compression and RIP in the printer controller 4 is transmitted to the multinary processor 103c, where the data is converted to multinary data, and the converted data is transmitted to the multinary data resolution converter 104. On the other hand, the binary monochrome data that has been subjected variable-length reversible compression and RIP in the printer controller 4 is transmitted to the binary data resolution converter 105.

The multinary data of CMYK derived from the color copy data is converted to the RGB system by a color space converter (1) 106a in the same manner as the first embodiment. The gray scale data derived from the color copy data and the monochrome copy data is converted to a general compressed image by a multinary general format compressor (1) 107a. JPEG or the like is applied as a multinary general format compression method to be used in this case.

On the other hand, the multinary data of CMYK derived from the color printer data is converted to the RGB system for index colors having a color lookup table by a color space converter (2) 106c. The RGB images of the index colors are converted to general compressed images by a multinary general format compressor (2) 107c. A TIFF compression method having an index table of RGB is applied as the multinary general format compression method to be used in this case.

The monochrome binary data of which resolution has been converted to binary resolution is transmitted to the binary general format compressor 108 in the same manner as that of the second embodiment, and the data is compressed in a binary general format.

These compressed images are again transferred to the semiconductor memories 11 on the printer controller 4 from the output port 109 through the general bus 15, and are handled as reference images.

The printer controller 4 transmits the image compressed and stored in the HDD 5 through the semiconductor memories 11 when the image is input and the compressed image for reference created in the image format converter 30, to the external PC 19 through the NIC 14. The external PC 19 integrally manages the compressed images to allow the contents of the compressed data to be easily identified and the stored image with high image quality to be ensured. Therefore, it is possible to manage these compressed data in the external PC 19 as backup data for the compressed data stored in the copying machine. When the backup data is to be used again, the compressed data for reference is abandoned on the external PC 19, but only the data of the internal compression format is returned to the printer controller 4 through the NIC 14, and is stored in the HDD 5.

As explained above, in the third embodiment, the image format is changed depending on the type of the original data stored in the HDD 5. In this embodiment, three types of outputs are conducted so that if the reference image is a multinary image, then the original image is indicated as a copy image with high image quality, and if the reference image is a binary or index color image, then the original image is indicated as a printer or FAX image. Therefore, in the third embodiment, it is possible to identify the original data from the corresponding reference image while in the first and second embodiments, whether the original image has been copied or printed is hard to find out instantly from the reference image created using the method according to the embodiments. Thus, it is easy for the user to sort out the backup images.

The fourth embodiment of the present invention is explained below. The fourth embodiment is intended to further improve identification of an image by changing the size of its reference image in correlation with the resolution of its original image to allow the resolution of the original image to be identified at once.

As means for this purpose, information managed on the printer controller 4 is used here.

All the images as management information are given attributes. For example, as the attributes of the internal compression format, pieces of information as follows are generally managed in correlation with the compressed image data.

Image size

Created date and hour of image

Unit where image is created

Image resolution

When resolution is to be converted in the resolution converters 104 and 105 as exemplified in the third embodiment (see FIG. 9), a conversion rate is determined so as to become a predetermined value by referring to the resolution in the information managed as the attributes that accompany the original image. In this manner, the image is easily identified.

Monochrome printer images are taken up as one example. These images have resolutions of 300 dpi, 600 dpi, and 1200 dpi, as explained above. If each conversion rate of all the images is set to one-eighth of their original size and the images are subjected to resolution conversion, the size of the images after the resolution conversion reflects the resolution of the original images. Accordingly, the size (resolution) of the original image is immediately recognized only by the size of its reference image. Although all the images are set to the size of one-eighth in this embodiment, it is also possible to achieve the identification of an image even if the conversion rate of the image is set to one-tenth when 1200 dpi, and set to one-eighth when 600 dpi and 300 dpi.

According to one aspect of the present invention, when a plurality types of input image data are compressed in a first data format and stored and the stored data is to be transmitted to outside, image data for reference obtained by converting the first data format of the stored data to a second data format being a general data format is transmitted together with the stored image data of the first data format. Therefore, if an external device receiving the data has a general processing function, it is possible to easily identify the contents of the received data and use the stored data as original data without its degradation. Thus, it is possible to improve the usability of the data such that the reference image data is used as a backup.

Furthermore, the unit for converting the first data format of the stored data to the second data format includes a function that converts image data of low bits to multinary image data and compresses the multinary image data in a multinary general compression format. Therefore, all the images are integrated into a signal format, which makes it easy to perform processing on the receiving side of the reference image.

Moreover, the unit for converting the first data format of the stored data to the second data format includes a function that converts monochrome multinary image data to binary image data and compresses the binary image data in a binary general compression format. The data format of a monochrome image is converted into a binary general format irrespective of multinary or binary data. Therefore, it is possible to reduce the data amount of the reference image.

Furthermore, the unit for converting the first data format of the stored data to the second data format includes a color space converter that converts the color space of color multinary image data to a general color space. Therefore, it is possible to adapt the image data to a color image. Moreover, by changing conversion characteristic of the color space to appropriate one, it is possible to provide identification of image types to the apparatus.

Furthermore, the unit for converting the first data format of the stored data to the second data format performs resolution conversion corresponding to multinary and binary data. Therefore, it is possible to make appropriate use of reference images. In addition, a conversion rate is set such that the resolution of the image data as a base of conversion and a resolution after the conversion are fallen into a predetermined range. Therefore, it is possible to ensure accurate identification of image types.

Moreover, the present invention is applied to an image processing apparatus including a unit that forms an image on a recording medium based on the image data stored in the image storage unit. Therefore, it is possible to achieve compatibility between an image forming function and a stored image data transmitting function, and improve performance of the apparatus.

The present document incorporates by reference the entire contents of Japanese priority document, 2002-304623 filed in Japan on Oct. 18, 2002.

Although the invention has been described with respect to a specific embodiment for a complete and clear disclosure, the appended claims are not to be thus limited but are to be construed as embodying all modifications and alternative constructions that may occur to one skilled in the art which fairly fall within the basic teaching herein set forth.

What is claimed is:

1. An image processing apparatus comprising:
an image storage unit that stores a plurality types of image data in a first data format and that is compressed;
a data format converter that converts the first data format of the image data to a second data format being a general data format; and
a communicator including
a communication interface that transmits the image data of the first data format and the image data of the second data format as reference image data for the image data of the first data format.

2. The image processing apparatus according to claim 1, wherein the data format converter comprises:
an expandor that expands the image data stored in the image storage unit;
a multinary unit that converts image data expanded of low bits to multinary image data; and
a data compressor that compresses the multinary image data in a multinary general compression format.

3. The image processing apparatus according to claim 1, wherein the data format converter comprises:
an expandor that expands the image data stored in the image storage unit;
a binary unit that converts the image data expanded, which is monochrome multinary image data, to binary image data; and
a data compressor that compresses the binary image data in a binary general compression format.

4. The image processing apparatus according to claim 1, wherein the data format converter comprises:
a color space converter that converts a color space of the image data stored in the image storage unit, which is color multinary image data, to a general color space.

5. The image processing apparatus according to claim 1, wherein the data format converter comprises:
at least one resolution converter of a multinary resolution converter that performs resolution conversion on the image data stored in the image storage unit, which is multinary image data; and
a binary resolution converter that performs resolution conversion on the binary image data.

6. The image processing apparatus according to claim 5, wherein the resolution converter performs resolution conversion on image data at a conversion rate such that the resolution of the image data as a base of conversion and a resolution after the conversion are fallen into a predetermined range.

7. The image processing apparatus according to claim 1, further comprising:
an imaging unit that forms an image on a recording medium based on the image data stored in the image storage unit, wherein a printing function is combined with the imaging unit to adapt the first data format of the image data stored in the image storage unit to a data format used in the imaging unit.
